(19) United States
(12) Patent Application Publication
(10) Pub. No.: US 2014/0092245 A1
(43) Pub. Date: Apr. 3, 2014

(54) INTERACTIVE TARGET VIDEO DISPLAY SYSTEM

(71) Applicants: ORRIN LEE MOORE, TUSTIN, CA (US); BRETT LEE MOORE, TUSTIN, CA (US)

(72) Inventors: ORRIN LEE MOORE, TUSTIN, CA (US); BRETT LEE MOORE, TUSTIN, CA (US)

(21) Appl. No.: 14/034,933

(22) Filed: Sep. 24, 2013

Related U.S. Application Data
(60) Provisional application No. 61/706,779, filed on Sep. 28, 2012.

(51) Int. Cl. H04N 7/18

(52) U.S. Cl. CPC H04N 7/18
USPC 348/143

(57) ABSTRACT

An interactive target video display system is disclosed. The system includes a camera located in conjunction with a shooting lane at a shooting range. The camera is connected to a display monitor in the shooting station of the shooting lane, which displays a video image of the target. A protective screen covers the display monitor, and the shooter may write on the cover using a writing implement.

### RELATED APPLICATION

This application claims priority to provisional patent application U.S. Ser. No. 61/706,779 filed on Sep. 28, 2012, the entire contents of which is herein incorporated by reference.

### BACKGROUND

The embodiments herein relate generally to a video system for displaying targets at a shooting range.

People use shooting ranges to improve accuracy, to test new equipment, for recreational purposes, for self-defense training, and so on. Every shooter eventually positions their target at a distance that is too far to be seen by an unaided human eye. Unable to see the impact points on the target, the shooter has no idea if they are hitting the target or improving their accuracy with each round fired. The shooter will inevitably become frustrated with the lack of feedback and having to waste time repetitively retrieving the target, which leads to an unsatisfying experience at shooting ranges.

Current solutions simply replace or enhance the shooter's own vision, often introducing problems or complications in the process. No current solution augments the shooter's visions while also enhancing his experience at the shooting range. For example, electronic targets are prone to computer system errors and require re-calibration often. Spotting scopes need to be re-focused each time they are set-up or attempt to show a target at a different distance. Current video systems only display an image of the target. They do not offer a way for the shooter to interact with the target.

### SUMMARY

According to one embodiment of the present invention, a target display system for a shooting range is configured to allow a shooter to interact with a video image of the target using a writing implement. The system includes a first video camera, a first display monitor, and a cover attached to the first display monitor. The first video camera is configured to be housed in a protective housing. The first video camera is also configured to be aimed at a first predetermined position on a shooting range and to capture a video image of a target positioned at the first predetermined position. The first display monitor is configured to be located so that it can be seen by the shooter without breaking his shooting stance. The first display monitor is configured to be connected to the first video camera and to receive and display the video image of the target from the first video camera. The cover is configured to protect the first display monitor from one or more hazards associated with the shooting range while allowing the shooter to view the monitor. The cover is also configured to permit the shooter to erasably write on the cover, thereby interacting with the image of the target displayed on the first display monitor.

In addition, the first display monitor may be configured to be activated only by a modified remote control, thereby limiting access to and use of the target display system. The first display monitor may be configured to display an advertisement when it is not displaying an image of the target. The system may also include a second video camera configured to be aimed at a second predetermined position on the shooting range and to capture a video image of a target positioned at the second predetermined position. The first display monitor may be configured to be connected to the second video camera and to receive and display the video image of the target from the second video camera. The first display monitor may also be configured to be controllable by the shooter to display at least one of the video image from the first video camera and the video image from the second video camera. The system may include a plurality of video cameras, which includes the first video camera, the second video camera, and at least one additional video camera configured to be aimed at an additional predetermined position on the shooting range and to capture a video image of a target positioned at the additional predetermined position. The first display monitor may be configured to be connected to the additional video camera and to receive and display the video image of the target from the additional video camera. The first display monitor may also be configured to be controllable by the shooter to display at least one of the video image from the first video camera, the video image from the second video camera, and the video image from the additional video camera. The system may include a second display monitor configured to be located so that it can be seen by a patron of the shooting range, the second display monitor configured to be connected to the first video camera and to receive and display the video image of the target from the first video camera. The system may include a second display monitor configured to be located in a safe public area associated with the shooting range. The second display monitor may be configured to be connected to a plurality of target display systems associated with independent lanes of the shooting range. The second display monitor may also be configured to display a video image of a target from at least one of the target display systems. The first display monitor may be connected to the first video camera by a wireless link. The first video camera may be configured to be aimed at a second predetermined location on the shooting range and to capture a video image of a target at the second predetermined location. The first video camera may also be configured to have its aim controlled by the shooter to move between the first predetermined location and the second predetermined location. The first video camera may be configured to track the target to a position on the shooting range selected by the shooter and to capture a video image of the target at the selected position. The system may include a computer system connected to the first video camera. The computer system may include software programmed to process the video image of the target and to control the first video camera to track the target as the target is moved to a position on the shooting range. The first video camera may be configured to be housed in a protective housing. The first video camera may be configured to be housed in a protective housing, and the second video camera may be configured to be housed in a protective housing.

### BRIEF DESCRIPTION OF THE FIGURES

The detailed description of some embodiments of the present invention is made below with reference to the accompanying figures, wherein like numerals represent corresponding parts of the figures.

FIG. 1 shows a perspective view of an embodiment of the present invention, comprising a video camera.

FIGS. 2 and 3 show a perspective view of an alternate embodiment of the present invention, comprising two video cameras.

FIGS. 4 and 5 shows a schematic view of an additional embodiment of the present invention, comprising a display monitor in a public area.

FIG. 6 shows a schematic view of a further embodiment of the present invention, comprising a video camera configured to be aimed at multiple positions.

### DETAILED DESCRIPTION OF CERTAIN EMBODIMENTS

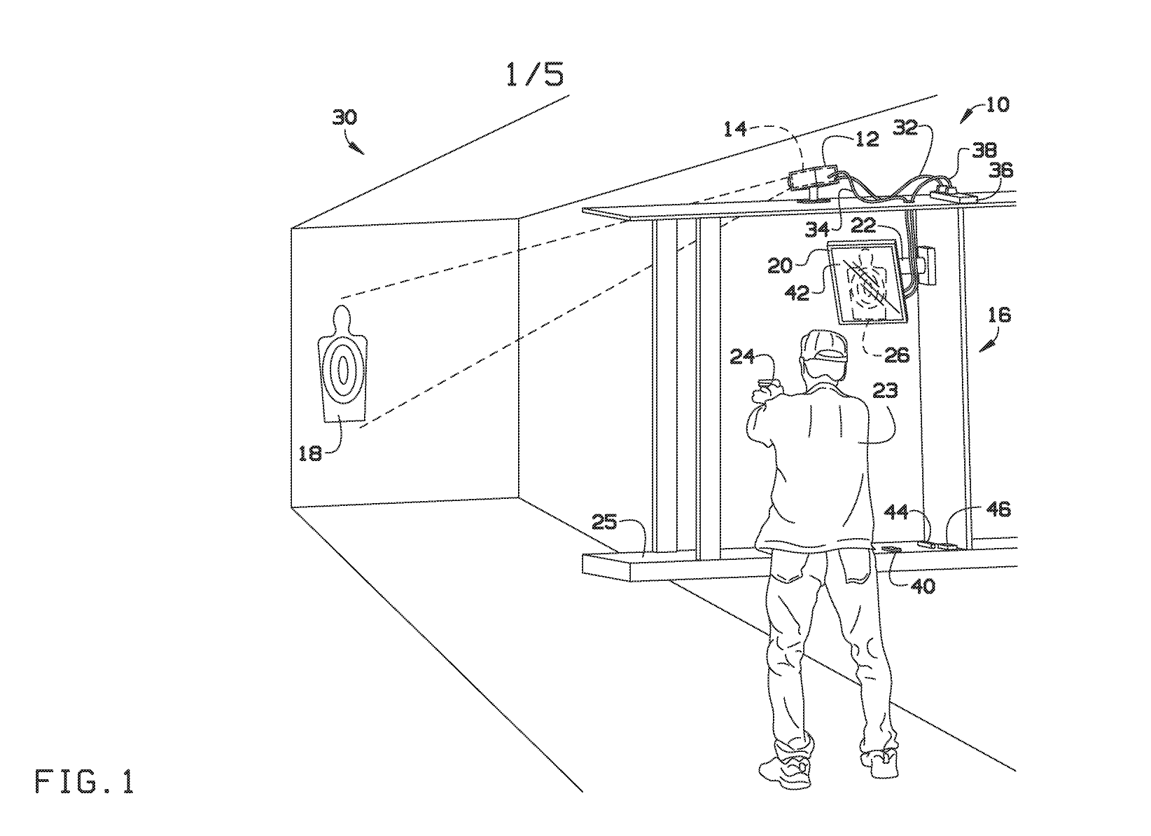

By way of example, and referring to FIG. 1, one embodiment of the present invention comprises a video system 10 for displaying targets at a shooting range. The system 10 may include a protective camera housing 12 with a video camera 14 inside. The housing 12 may be mounted onto the shooting station 16 and aimed directly at a target 18. The protective camera housing 12 may be mounted in various locations, such as, e.g., either left or right side wall, on top, below, and so on. A display monitor 20 may be mounted on the shooting station 16 with a monitor mounting bracket 22 so that the monitor 20 is visible to a shooter 23 with a firearm 24 at the shooting station 16. For example, the display monitor 20 and mounting bracket may be mounted on the left side wall, on the right side wall, on the shooting bench 25, hanging from the shooting station 16, and so on.

The display monitor 20 may be connected to the video camera 14 so that the monitor 20 may display a video image 26 captured by the camera 14. The video camera 14 and the protective housing 12 may be aimed at a fixed position on a shooting lane 30 associated with the shooting station 16. The video camera 14 may be attached to a power cable 32, a video cable 34, or both. The power cable 32 may exit the housing 12 and connect to a power outlet 36. The video cable 34 may exit the housing 12 and connect to the monitor 20. The display monitor may be connected to a power cable 38, which may also connect to a power outlet 36. The monitor 20 may be configured so that it can only be controlled by a special or customized remote control 40. By controlling the remote control 40, staff at the shooting range may be able to limit or control access to the system 10, for example, to only customers who have paid an extra fee. When not in use, the monitor 20 may be off, or it may display advertisements, television programming, or other content. Advertisements may include, for example, still images and text, still images and audio, video and text, video and audio, any combination of the foregoing, and so on.

A cover 42 may be attached to the display monitor 20 to protect it from one or more hazards present in the shooting station 16, such as, e.g., ejected shells casings. The cover 42 may be partially or substantially transparent so that it does not interfere with the shooter's view of the monitor 20. The cover 42 may be configured to allow the shooter 23 to interact with the monitor 20, the image 26 on the monitor, or both. For example, the cover may include a dry erase surface so that the shooter 23 or another person may write on the cover with a writing implement 44, such as dry erase marker 44A. Once the shooter 23 fires their firearm 24, a projectile may strike the target 18. The display monitor 20 may show exactly where the projectile impacts the target 18. Without leaving their shooting stance or position, the shooter 23 may look at the display monitor 20 to see where their projectile impacted the target 18. The shooter may visually evaluate the impact on the target 18 as shown on the display monitor 20. They may adjust their shooting fundamentals, if necessary, and fire again. After each magazine is completed, the shooter 23 may use a dry erase pen 19 to mark impact points on the cover 42. A group of shooters may shoot on one target 18 and use different colored dry erase pens 44A to distinguish the impacts of each shooter 23. Thus, a target 18 may be used for a longer period of time or left on the range for a longer period of time. The markings may be wiped away with a dry eraser 46 or other implement. As an alternative, the monitor 20 may incorporate a touchscreen, especially if the cover 42 is built into the monitor 20. In this example, the writing implement 44 may include a touchscreen stylus 44B, a finger 44C, or the like. This type of interaction may, for example, essentially allow the shooter 23 to “write” on the display monitor 20 with a stylus 44B or finger 44C. As used herein, the term “writing implement” includes traditional writing tools, such as pens, markers, pencils, and so on. The term “writing implement” also includes tools that may be used to interact with a touchscreen, including, e.g., a stylus, one or more fingers, and so on.

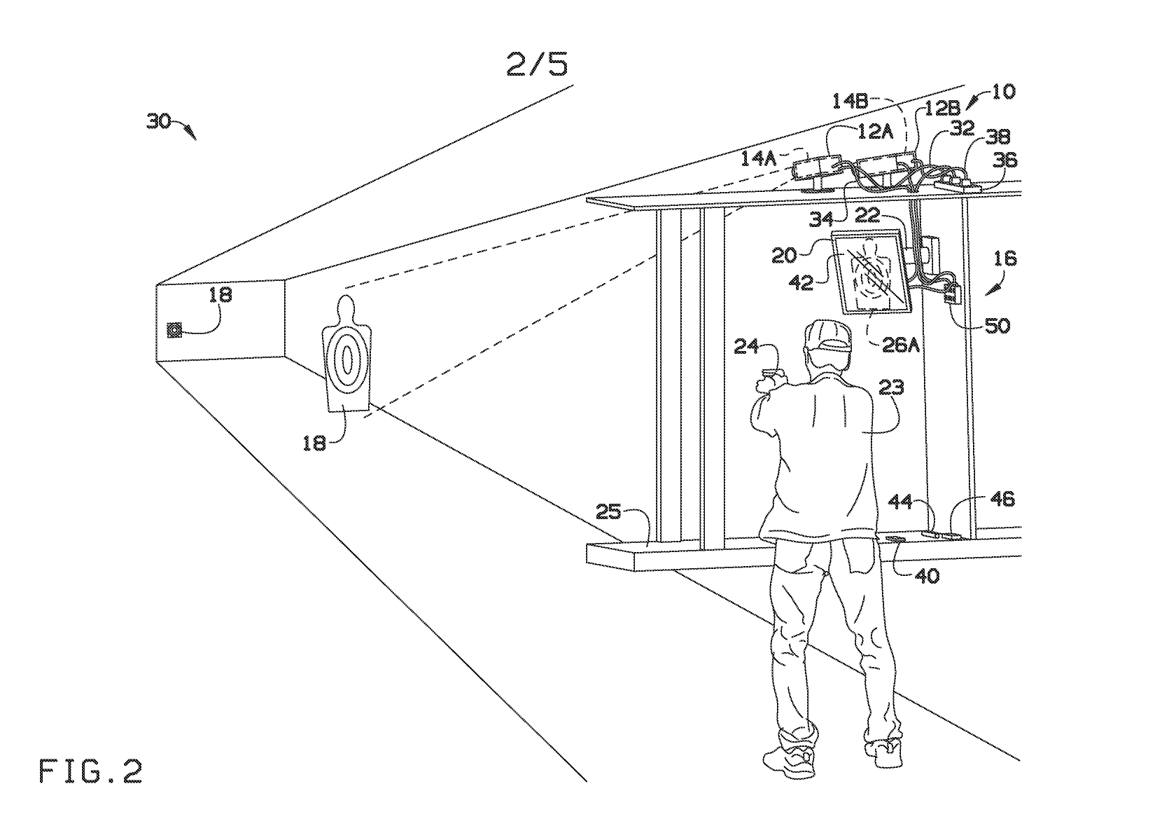

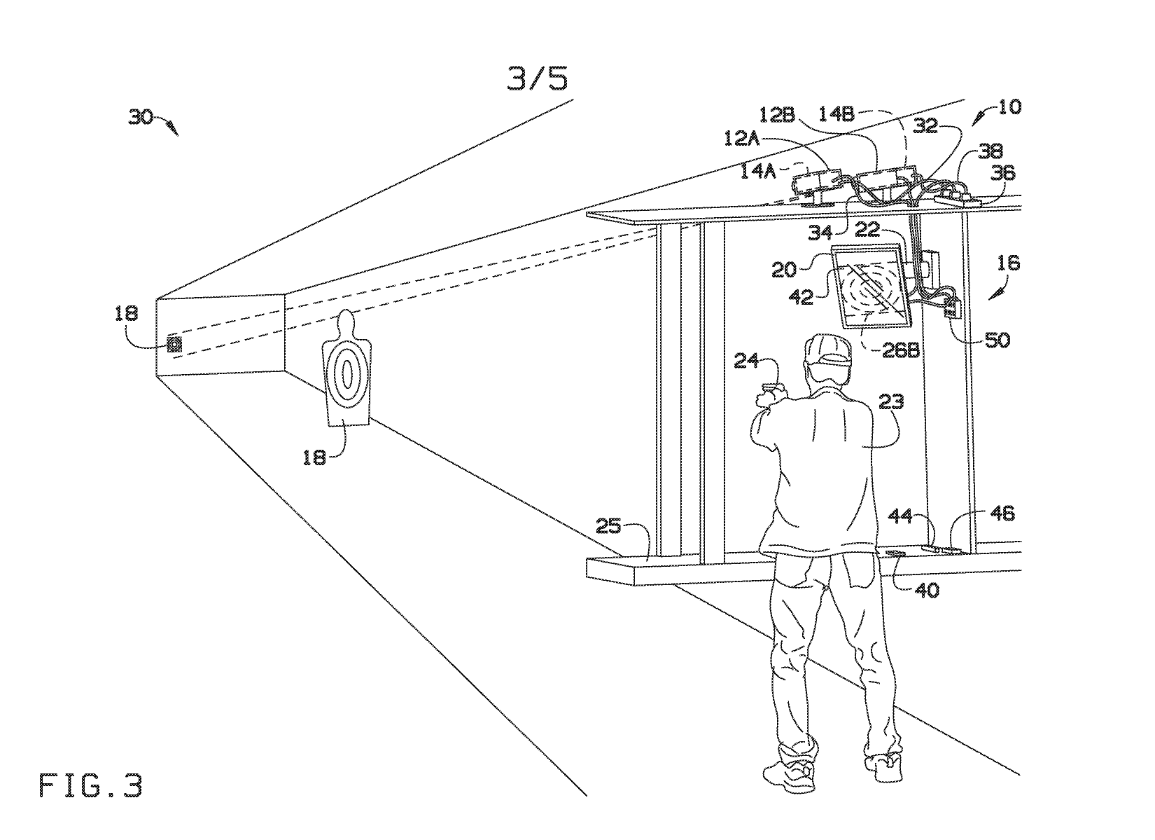

Referring to FIGS. 2 and 3, the video system 10 may include multiple video cameras 14 and camera housings 12. For example, the system 10 may include two video cameras, a near camera 14A and a far camera 14B. The near camera 14A may be aimed at a fixed position closer to the shooting station 16, while the far camera 14B may be aimed at a fixed position farther from the shooting station 16. The cameras may be housed in separate protective housings 12A and 12B. A video signal switch 50 or the like may be used to switch the display monitor from displaying the video image 26A from the near camera 14A to displaying the video image 26B from the far camera 14B, and vice versa.

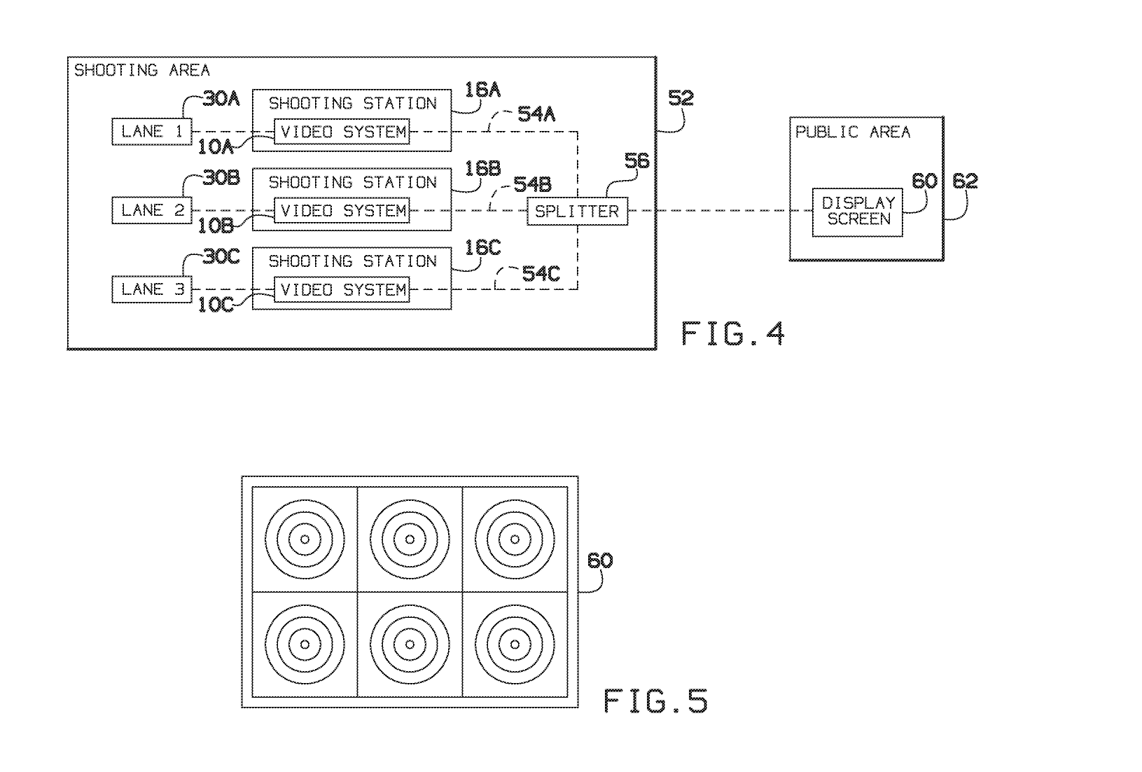

Referring to FIGS. 4 and 5, a shooting area 52, such as, e.g., a shooting range, may include multiple shooting stations 16A, 16B, 16C associated with shooting lanes 30A, 30B, 30C. One or more shooting stations 16A, 16B, 16C may have its own video system 10A, 10B, 10C. Video cables 54A, 54B, 54C may connect the video systems 10A, 10B, 10C to a splitter 56. The video systems 10A, 10B, 10C may be configured to provide a video image 26 currently being viewed by a shooter 23 to the splitter 56. The splitter 56 may select and/or combine one or more of the video images 26 from the video systems 10A, 10B, 10C. The output of the splitter 56 may be shown on a display screen 60 in a public area 62 associated with the shooting area 52, such as, e.g., a store, a viewing gallery, or the like. The splitter 56 may be located, for example, in or in proximity to the shooting area 52, where it may be closer to the video systems 10A, 10B, 10C, or the splitter 56 may be located in or in proximity to the public area 62, where it may be closer to the display screen 60.

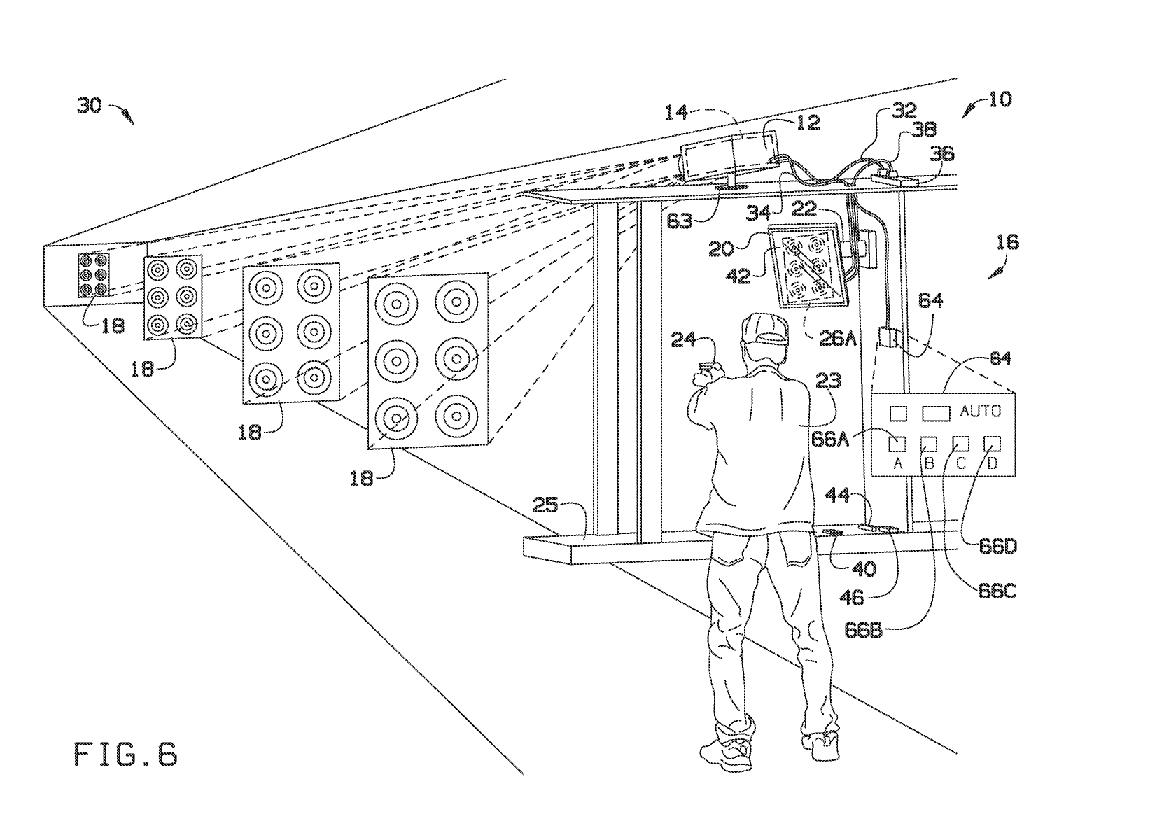

Referring to FIG. 6, the video system may include an adjustable or repositionable mount 63 for the camera housing 12 and video camera 14. The mount 63 may allow the housing 12 and/or the camera 14 to track the target 18. The camera 14 may include an automatic focusing feature. One or more systems or techniques may be used to correctly aim the camera 14 at the target 18. For example, a control box 64 in the shooting station 16 may have four different buttons 66A, 66B, 66C, 66D. Each button may correspond to a preset target distance or position. For example, button 66A may aim the camera 14 at a target 18 that is 15 feet from the shooting station 16, and button 66B may aim the camera 14 at a target 18 that is 25 feet from the shooting station 16. Any number of buttons 66 may be used, and any distance may be assigned to a button 66. Image processing may be used to allow the camera 14 to track the target 18. For example, colored stickers may be placed on the corners of the target, and the stickers may allow a computer system to identify the target 18 in the video image 26. If the target 18 moves, the computer may be connected to or otherwise configured to control the mount 63 to keep the target 18 in view of the camera 14. Alternatively, the target 18 may be printed using special symbols or colors, which may act similarly to the color stickers. Likewise, the image processing software may be programmed to identify and track a target 18 with a particular size or shape. The mount 63 may be connected to a target retrieval system for the shooting lane 30. This may allow the system 10 to know the distance where the shooter 23 has positioned the target 18 to automatically adjust the camera 14 to aim at the target 18. The system 10 may include manual controls, such as, e.g., a joystick and one or more buttons, to allow the shooter 23 to manually aim and adjust the camera 14 to view the target 18.

The target video display system 10 may use any type of connector appropriate to the application at hand, including both analog and digital connectors. The connectors may include, for example, VGA, RCA, BNC, or HDMI connectors. The use of Hi-Res or megapixel digital cameras, cables, connectors, and/or displays may increase the resolution and effectiveness of the system 10. Direct wire connections may be replaced by wireless video transmission. For targets at longer distances, the camera housing 12 and the video camera 14 may be mounted closer to the target, for example, behind a protective wall or barrier.

An additional video camera with a wide angle lens may be added to the top of the display monitor 20 or another location in the shooting station 16. The additional camera may record the shooter 23 shooting their firearm 24. This video image may be displayed on the larger public display monitor 60 for the public to see. The video may be recorded with a digital video recorder (DVR) to sell or give away to the shooter via, e.g., email video file, download from a website, and so on. In addition, video recording equipment (DVR) may be used with the system 10 to provide footage for further analysis or other uses.

As will be apparent to those skilled in the art, the target video display system 10 is not limited in use to a single type of shooting or sport. The system described herein may be used with indoor or outdoor shooting ranges. Tactical, military or law enforcement shooting facilities may use the target video display system. The system 10 may be used with sports such as golf (driving range), archery range (indoor or outdoor), baseball (batting practice), and so on.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A target display system for a shooting range configured to allow a shooter to interact with a video image of the target using a writing implement, the system comprising:
a first video camera configured to be aimed at a first predetermined position on a shooting range and to capture a video image of a target positioned at the first predetermined position;
a first display monitor located such that it can be seen by the shooter without breaking his shooting stance, the first display monitor configured to be connected to the first video camera and to receive and display the video image of the target from the first video camera; and
a cover attached to the first display monitor and configured to protect the first display monitor from a hazard associated with the shooting range while allowing the shooter to view the first display monitor, the cover further configured to permit the shooter to erasably write on the cover to interact with the image of the target displayed on the first display monitor.

2. The system of claim 1, wherein the first display monitor is configured to be activated only by a modified remote control, thereby limiting access to and use of the target display system.

3. The system of claim 1, wherein the first display monitor is configured to display an advertisement when it is not displaying an image of the target.

4. The system of claim 1, further comprising:
a second video camera configured to be aimed at a second predetermined position on the shooting range and to capture a video image of a target positioned at the second predetermined position;
wherein the first display monitor is further configured to be connected to the second video camera and to receive and display the video image of the target from the second video camera, the first display monitor further configured to be controllable by the shooter to display at least one of the video image from the first video camera and the video image from the second video camera.

5. The system of claim 4, further comprising:
a plurality of video cameras comprising the first video camera, the second video camera, and at least one additional video camera configured to be aimed at an additional predetermined position on the shooting range and to capture a video image of a target positioned at the additional predetermined position;
wherein the first display monitor is further configured to be connected to the additional video camera and to receive and display the video image of the target from the additional video camera, the first display monitor further configured to be controllable by the shooter to display at least one of the video image from the first video camera, the video image from the second video camera, and the video image from the additional video camera.

6. The system of claim 1, further comprising:
a second display monitor located such that it can be seen by a patron of the shooting range, the second display monitor configured to be connected to the first video camera and to receive and display the video image of the target from the first video camera.

7. The system of claim 1, further comprising:
a second display monitor located in a safe public area associated with the shooting range, the second display monitor configured to be connected to a plurality of target display systems associated with independent lanes of the shooting range, the second display monitor further configured to display a video image of a target from at least one of the target display systems.

8. The system of claim 1, wherein the first display monitor is connected to the first video camera by a wireless link.

9. The system of claim 1, wherein the first video camera is further configured to be aimed at a second predetermined location on the shooting range and to capture a video image of a target at the second predetermined location, the first video camera further configured to have its aim controlled by the shooter to move between the first predetermined location and the second predetermined location.

10. The system of claim 1, wherein the first video camera is further configured to be manually aimed at a position on the shooting range selected by the shooter and to capture a video image of the target at the selected position.

11. The system of claim 1, wherein the first video camera is further configured to track the target to a position on the shooting range selected by the shooter and to capture a video image of the target at the selected position.

12. The system of claim 11, further comprising:
a computer system connected to the first video camera and comprising software programmed to process the video image of the target and to control the first video camera to track the target as the target is moved to a position on the shooting range.

13. The system of claim 1, wherein the first video camera is configured to be housed in a protective housing.

14. The system of claim 4, wherein the first video camera is configured to be housed in a protective housing, and the second video camera is configured to be housed in a protective housing.
